(19) United States
(12) Patent Application Publication
(10) Pub. No.: US 2017/0344385 A1
(43) Pub. Date: Nov. 30, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Takenori Asami, Kawasaki-shi (JP)

(21) Appl. No.: 15/601,910

(22) Filed: May 22, 2017

(30) Foreign Application Priority Data
May 31, 2016 (JP) 2016-109336

(51) Int. Cl. G06F 9/44; G06F 9/455; G06F 9/54

(52) U.S. Cl. CPC G06F 9/4445; G06F 9/542; G06F 9/45533; G06F 2209/545

(57) ABSTRACT

An information processing apparatus for running an application on a virtual machine includes a management unit configured to manage a window of an application different from the application run on the virtual machine on a window management system, a first generation unit configured to generate a base window capable of event notification from the window management system on the window management system, and a second generation unit configured to generate a window included in display of the application run on the virtual machine in a hierarchical structure with the base window as a top level.

### BACKGROUND OF THE INVENTION

### Field of the Invention

The aspect of the embodiments relates to an information processing apparatus, an information processing method, and a storage medium for running an application on a virtual machine.

### Description of the Related Art

Some application platforms have conventionally used two different types of window systems. For example, as illustrated in FIG. 1, an application platform may use two different types of window systems, i.e., the X Window System® and a Java® virtual machine (VM) window system. In FIG. 1, a native window manager and a Java VM are respective different modules present on the application platform. The Java VM uses the Java VM window system to generate a window of a Java language application. The native window manager generates windows of native applications and transmits events to the windows of all the applications. The native window manager commands to generate windows and transmits events to the windows through interfaces of the respective window systems. In the X Window System, windows are generated in a hierarchical structure having a parent-child relationship under a top-level window called XRootWindow. For example, as illustrated in FIG. 1, a child BASEWindow3 is generated under XRootWindow. Two child Panel and Frame are further generated under BASEWindow3 . The hierarchical structure is used to determine a target window to receive an event. For example, a window at the bottom of the hierarchical structure among windows underlying a cursor position is determined to be a target window.

The Java VM window system generates a window by a method different from that of the X Window System. In FIG. 1, the Java VM windows shares a BASEWindow which is generated by the X Window System. Other components such as Button, Label, Frame, and Panel are parts serving as substitutes for windows, and are generated by the Java VM window system. The components Button, Label, Frame, and Panel are drawn on the BASEWindow. The destination for the native window manager to transmit an event to is the BASEWindow. The Java VM window system initially receives the event with the BASEWindow. Based on the cursor position of the event, the Java VM window system then controls a component drawn in the foreground at that position to process the event.

The native window manager switches the window system to transmit an event depending on applications. For example, during execution of a native application, the native window manager transmits an event to the X Window System. During execution of a Java language application, the native window manager transmits an event to the Java VM window system. According to the conventional technique, two different types of window systems are used as described above.

Since the conventional technique uses two different types of window systems, the event notification processing performed by the native window manager may cause overhead. For example, event formats need to be converted into formats compatible with the respective window systems, which can cause overhead. On the other hand, if the window systems are integrated into one type, some events transmitted from the native window manager may fail to reach an intended window depending on the generation method of the window.

### SUMMARY OF THE INVENTION

According to an aspect of the embodiments, an apparatus for running an application on a virtual machine includes, a management unit configured to manage a window of an application on a window management system, the application being different from the application run on the virtual machine, a first generation unit configured to generate a base window on the window management system, the base window being capable of event notification from the window management system, and a second generation unit configured to generate a window in a hierarchical structure with the base window as a top level, the window being included in display of the application run on the virtual machine.

Further features of the disclosure will become apparent from the following description of exemplary embodiments with reference to the attached drawings.

### BRIEF DESCRIPTION OF THE DRAWINGS

FIG. 1 is a block diagram illustrating an example of a hierarchical structure of a plurality of windows according to a conventional technique.

FIG. 2 is a block diagram illustrating a hardware configuration.

FIG. 3 is a block diagram illustrating components of a system according to a first exemplary embodiment.

FIGS. 4A and 4B are a block diagram illustrating an example of a plurality of windows displayed on a display unit, and a block diagram illustrating an example of a hierarchical structure of a plurality of windows, respectively.

FIGS. 5A and 5B are flowcharts illustrating an example of BASEWindow generation processing, and an example of Java VM window generation processing, respectively.

FIG. 6 is a block diagram illustrating components of a system according to a second exemplary embodiment.

FIG. 7 is a flowchart illustrating an example of BASEWindow generation processing according to the second exemplary embodiment.

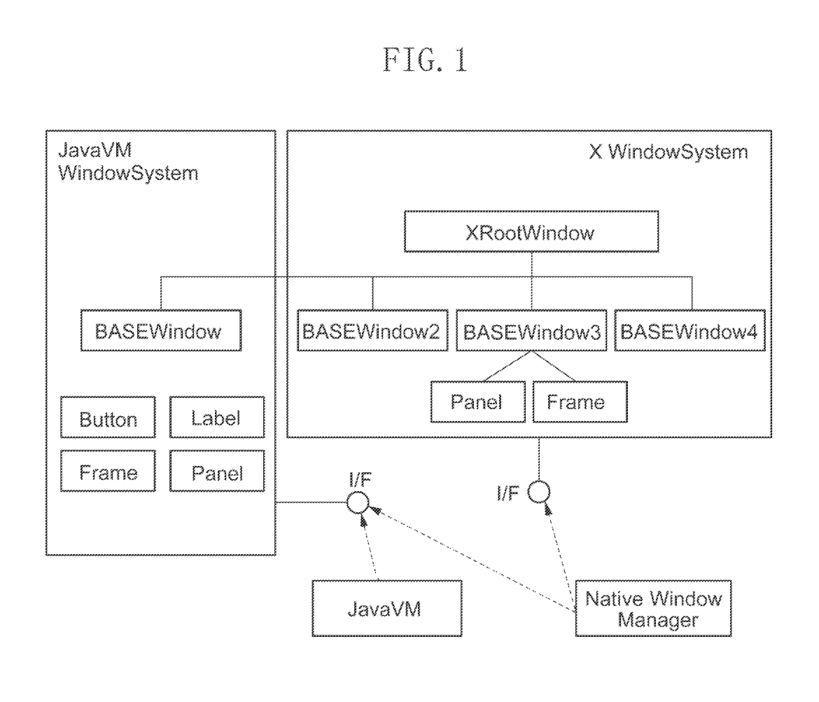

### DESCRIPTION OF THE EMBODIMENTS

Exemplary embodiments of the disclosure will be described in detail below with reference to the accompanying drawings. The configurations described in the following exemplary embodiments are just a few examples, and the disclosure is not limited to the configurations illustrated in the drawings.

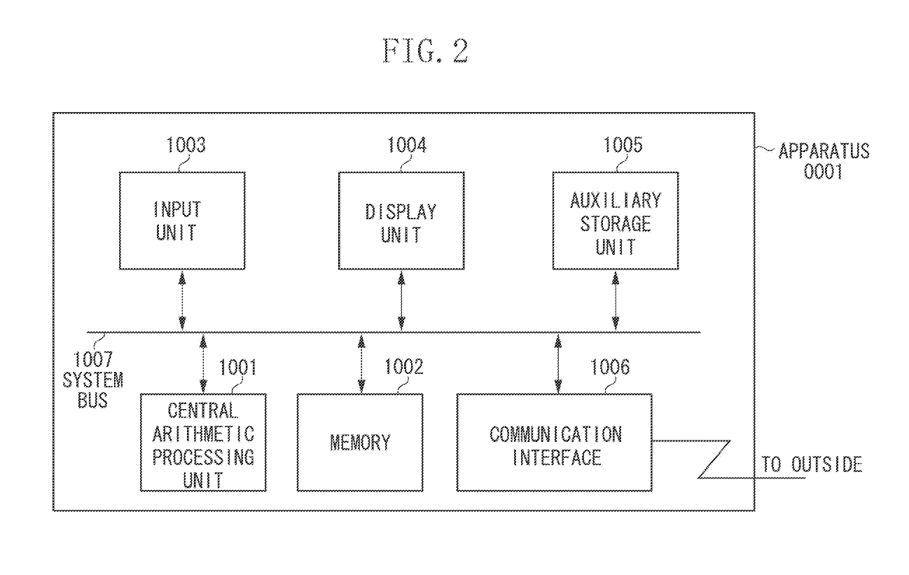

FIG. 2 is a diagram illustrating a hardware configuration of an apparatus according to a first exemplary embodiment.

A central arithmetic processing unit 1001 is an information processing device including an arithmetic unit. The central arithmetic processing unit 1001 executes various types of processing for controlling an operation of the entire apparatus 0001. The central arithmetic processing unit 1001 also executes processing of applications. A memory 1002 is a semiconductor memory such as a random access memory (RAM) and a read-only memory (ROM). The semiconductor memory stores window drawing data as well as temporary data during execution of a program. An input unit 1003 serves as an interface for inputting information when a user uses an application. Examples of the input unit 1003 include a keyboard, a mouse, and a touch device. A display unit 1004 displays a user interface, such as a window, on a screen. Examples of the display unit 1004 include a display device. An auxiliary storage unit 1005 is used to store various types of data. Examples of the auxiliary storage unit 1005 include a hard disk drive. A communication interface 1006 controls data input from and output to an external network. A system bus 1007 connects the foregoing units 1001 to 1006 and serves as an information transfer path between the units 1001 to 1006. The apparatus 0001 includes such a configuration.

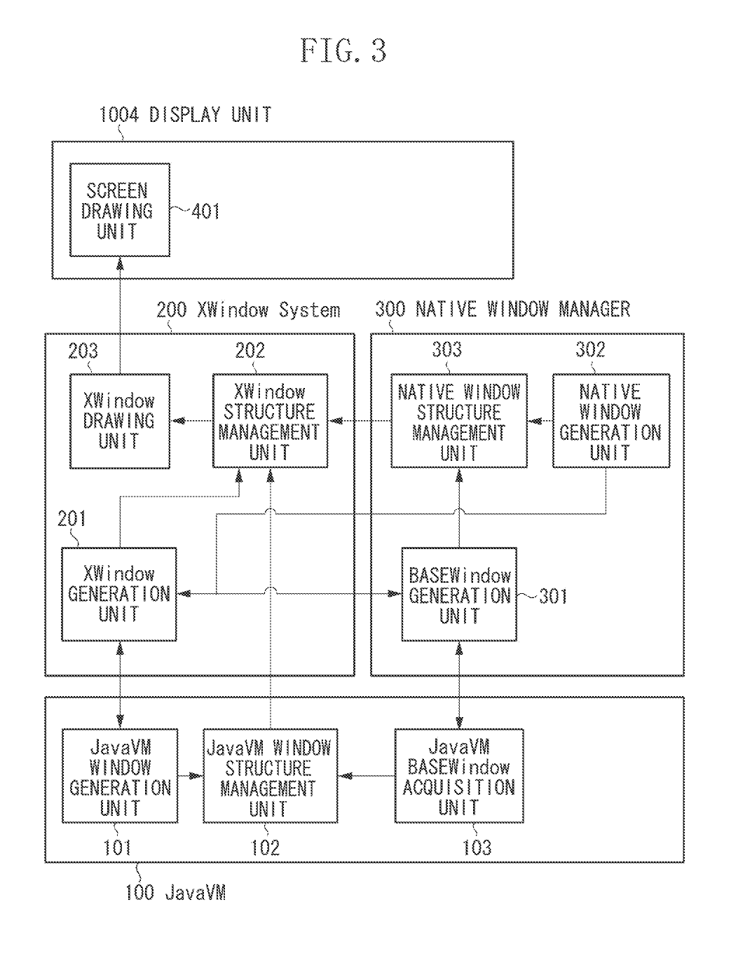

FIG. 3 is a block diagram illustrating components of a system for window management according to the present exemplary embodiment. The system includes a Java VM 100, an X Window System 200, a native window manager 300, and the display unit 1004. The X Window System 200 is a window management system and manages a plurality of windows on the window management system. The display unit 1004 corresponds to the display unit 1004 in FIG. 2.

The Java VM 100 is a virtual machine. The Java VM 100 includes a Java VM window generation unit 101, a Java VM window structure management unit 102, and a Java VM BASEWindow acquisition unit 103. The virtual machine can run an application or applications thereon.

The Java VM window generation unit 101 includes a function of generating a window. More specifically, the

Java VM window generation unit 101 commands an X Window generation unit 201 (described below) to reserve an identifier (ID) for identifying a window and reserve a memory area to display the window or to process the event. The reserved memory area is retained inside the X Window generation unit 201. A pointer to the reserved memory area (top address of the memory area) is stored by the Java VM window generation unit 101. The Java VM window generation unit 101 also stores information about the window, including the ID of the generated window, an ID of a parent window at the time of generation, a width, a height, and a display state (visible/hidden).

The Java VM window structure management unit 102 stores a hierarchical structure of all windows generated by the Java VM 100 (parent-child relationship of the windows) as data. The Java VM window structure management unit 102 also has a function of receiving information about a window generated by the Java VM window generation unit 101 and a function of inquiring of an X Window structure management unit about a window structure (described below).

A BASEWindow (base window) refers to a window located at the top level of the hierarchical structure of all the windows owned by the Java VM 100. The Java VM BASEWindow acquisition unit 103 has a function of obtaining a pointer to BASEWindow and information about BASEWindow from the native window manager 300. The X Window system 200 includes the X Window generation unit 201, an X Window structure management unit 202, and an X Window drawing unit 203. The X Window generation unit 201 has a function of generating a window. The X Window generation unit 201 reserves an ID for identifying a window and reserves a memory area to display the window or to process the event. The reserved memory area is retained by the X Window generation unit 201.

The X Window structure management unit 202 stores hierarchical structure data on all windows generated by the X Window generation unit 201. The X Window structure management unit 202 also has a function of receiving a window ID from an inquiry source and returning IDs of child and parent windows of that window.

The X Window drawing unit 203 has a function of generating graphic data for drawing a window on a screen.

The native window manger 300 includes a BASEWindow generation unit 301, a native window generation unit 302, and a native window structure management unit 303.

The BASEWindow generation unit 301 commands the X Window generation unit 201 to reserve an ID for identifying a window and reserve a memory area to display the window or to process the event. The BASEWindow generation unit 301 also has a function of passing the generated pointer to the generated window (BASEWindow) and information about the window to the Java VM BASEWindow acquisition unit 103. The BASEWindow generation unit 301 generates only one BASEWindow to be passed to the Java VM 100. However, the BASEWindow generation unit 301 can generate more than one BASEWindow. For example, the BASEWindow generation unit 301 generates another BASEWindow for a module other than the Java VM 100, such as a web application module. The BASEWindows are handled as windows at the top level of the hierarchical structure of the respective modules. The native window generation unit 302 has a function of generating a window other than a BASEWindow like the BASEWindow generation unit 301 has. The generated window is located in a layer lower than BASEWindow. The native window structure management unit 303 stores hierarchical structure data on all the windows including the BASEWindow(s). The native window structure management unit 303 also has a function of transmitting a command to switch display of windows to the X Window structure management unit 202. For example, to display a BASEWindow intended for the Java VM 100 in the most foreground position, the native window structure management unit 303 transmits a command to make that BASEWindow visible and hide the other BASEWindows. The display unit 1004 includes a screen drawing unit 401. The screen drawing unit 401 has a function of interpreting graphic data received from the X Window drawing unit 203 and displaying the graphic data on a display screen.

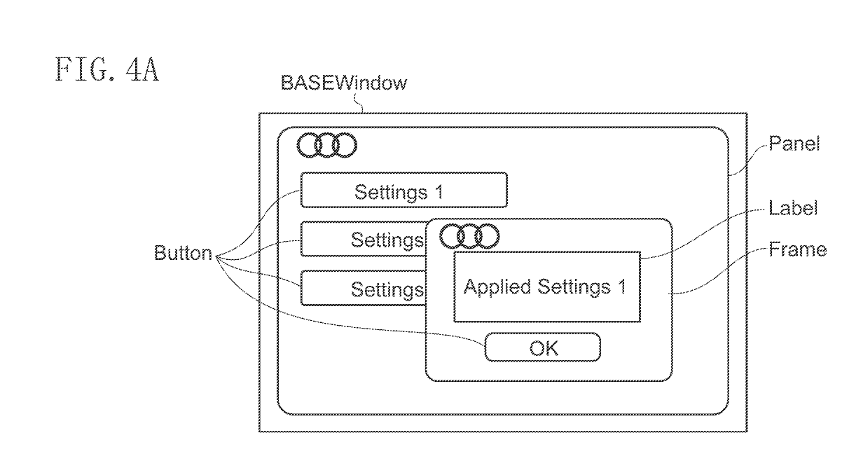

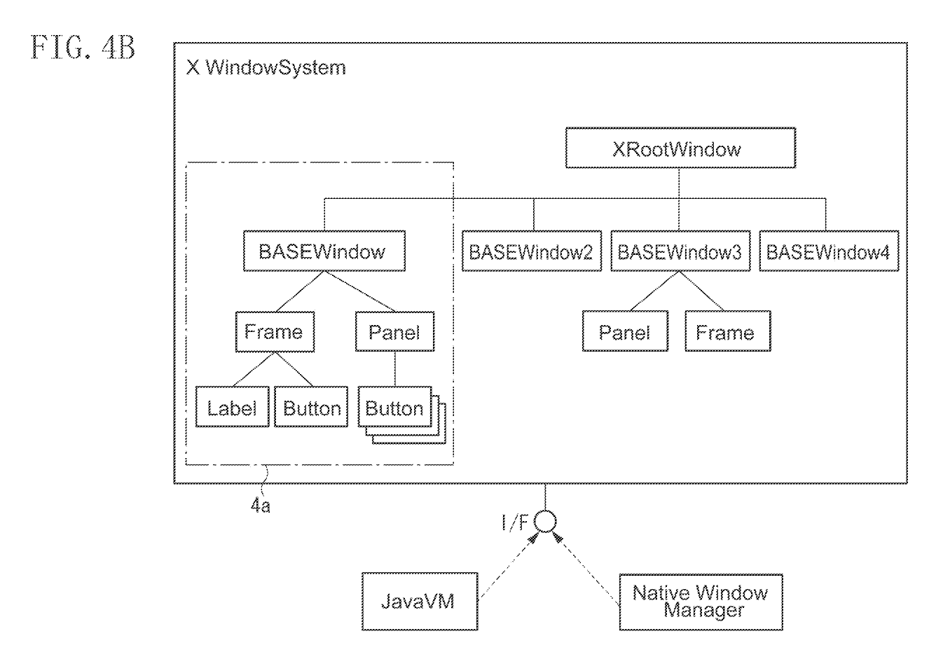

Next, an example of generating windows according to the present exemplary embodiment will be described with reference to FIGS. 4A and 4B. FIG. 4A illustrates an example of a plurality of windows displayed on the display unit 1004. FIG. 4A illustrates BASEWindow, Panel, Button, Label, and Frame which are all individual windows. The BASEWindow is located at the bottom layer. The Panel is displayed thereon. Three settings buttons (Button) are displayed on the Panel. If the user presses a settings button, the Frame appears. The Label and an OK button (Button) are displayed on the Frame.

FIG. 4B schematically illustrates a hierarchical structure of a plurality of windows generated by the X Window System 200, within the frame of the X Window System in FIG. 4B. A section 4a in FIG. 4B corresponds to the plurality of windows illustrated in FIG. 4A.

FIG. 4B illustrates four BASEWindows (BASEWindow, BASEWindow2, BASEWindow3, and BASEWindow4) which are windows generated by commands from the native window manager 300. The four BASEWindows are generated to be child windows of the top-level window, called XRootWindow, of the X Window System 200. A child window can be generated by specifying the ID of its parent window.

The four BASEWindows are managed by the native window manager 300. The native window manager 300 allocates the BASEWindows for respective different uses. For example, BASEWindow is allocated for a Java application, and BASEWindow2 is allocated for a native application. The BASEWindows are generated at a timing before the respective applications are activated. For example, suppose that the user makes operations to terminate the Java application and to start the native application. In such a case, the native window manager 300 closes BASEWindow and switches to display BASEWindow2. The native window manager 300 further switches the communication destination of the operation event from BASEWindow to BASEWindow2. Such processing is performed by the native window structure management unit 303 of the native window manager 300 transmitting a command to the X Window structure management unit 202.

In the section 4a of FIG. 4B, the windows other than BASEWindow are generated by commands from the Java VM 100. For example, the Panel and Frame are generated as child windows of BASEWindow. There are three windows Button (corresponding to the settings buttons in FIG. 4A) generated as child windows of the Panel. A Label and a Button (corresponding to the OK button in FIG. 4A) are generated as child windows of the Frame.

The native window manager 300 searches for a child window at the bottom layer under BASEWindow, and transmits an operation event to the window. For example, if a cursor is on the OK button in FIG. 4A and the user presses down the cursor, the native window manager 300 searches for a child window that is visible at the cursor position. The native window manager 300 then tracks down BASEWindow and Frame to reach the Button at the bottom level, and transmits the press-down event to the Button.

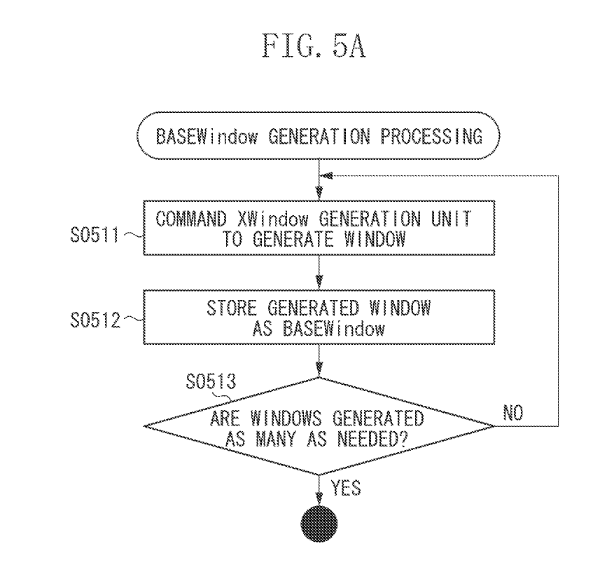

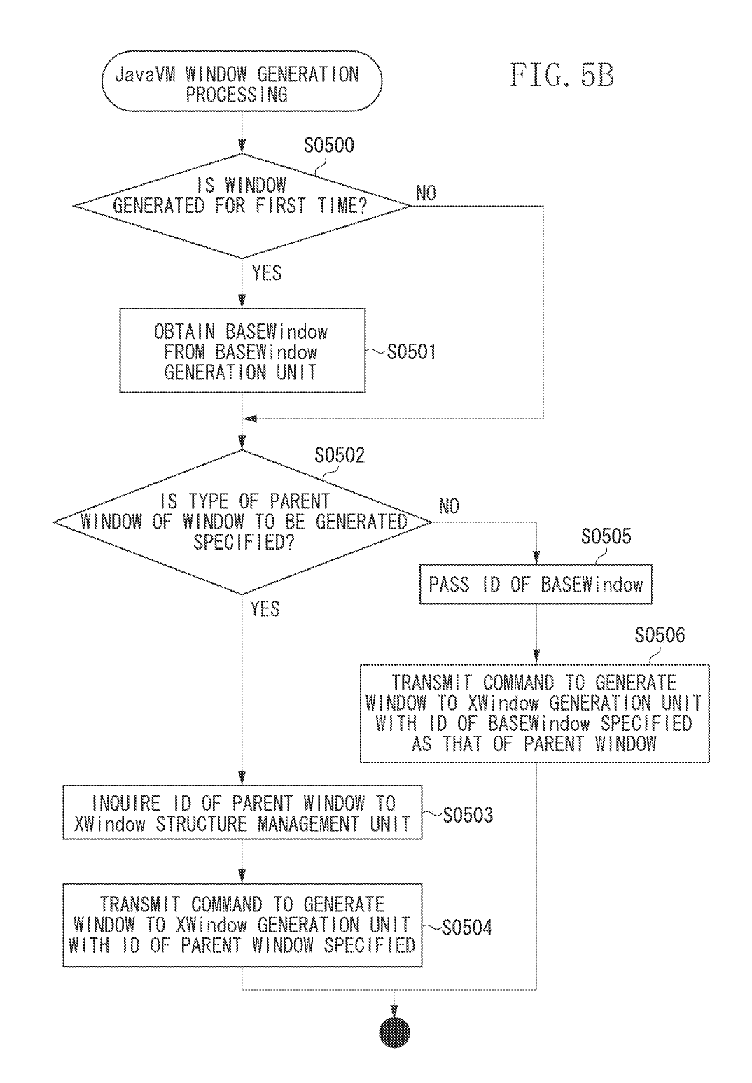

Next, detailed procedures of generating windows will be described with reference to the flowcharts of FIGS. 5A and 5B. Processing when the Java VM 100 generates windows (windows in the section 4a of FIG. 4B) will mainly be described.

The Java VM 100 initially performs BASEWindow generation processing illustrated in FIG. 5A. In step S0511 of the BASEWindow generation processing, the Java VM 100 initially commands the X Window generation unit 201 to generate a window. At that time, the Java VM 100 specifies the ID of XRootWindow as that of a parent window. The BASEWindow generation unit 301 stores the pointer to the generated window and information about the window. In step S0512, the BASEWindow generation unit 301 notifies the native window structure management unit 303 of the ID of the generated BASEWindow. In step S0513, such generation processing is repeated until windows are generated as many as needed. The Java VM 100 eventually generates the four BASEWindows illustrated in FIG. 4B. The number of required windows is set in advance.

The foregoing BASEWindow generation processing is performed before Java VM window generation processing illustrated in FIG. 5B. For example, the BASEWindow generation processing is performed when the native window manager 300 is activated. In other words, there already is a BASEWindow when the Java VM window generation processing is started. Next, the Java VM window generation processing will be described with reference to FIG. 5B.

In step S0500, if a window is generated for the first time (YES in step S0500), the processing proceeds to step S0501. In step S0501, the Java VM 100 obtains BASEWindow. More specifically, the Java VM BASEWindow acquisition unit 103 obtains the pointer to BASEWindow and information about the window from the BASEWindow generation unit 301. The Java VM BASEWindow acquisition unit 103 notifies the Java VM window structure management unit 102 of the ID of BASEWindow. The Java VM window structure management unit 102 stores the ID therein. In step S0502, the Java VM window structure management unit 102 checks whether the type of parent window of the window to be generated is specified. For example, if the window of Label of FIG. 4B is generated, the Label is specified by the Java program to be put on the Frame. According to this specification, the type of parent window is specified to be Frame (YES in step S0502). The processing then proceeds to step S0503. The Java VM window structure management unit 102 performs such processing according to a command from the Java VM window generation unit 101.

In step S0503, the Java VM window structure management unit 102 makes an inquiry to obtain the ID (window ID) of the Frame from the X Window structure management unit 202. The Java VM window structure management unit 102 passes the window ID of the Frame to the Java VM window generation unit 101. In step S0504, the Java VM window generation unit 101 transmits a command to generate the window of Label to the X Window generation unit 201, with the ID of the Frame specified as that of the parent window. In this way, the Label is generated as a child window of the Frame as illustrated in FIG. 4B.

On the other hand, if, for example, the window of Frame is generated, there is no such specification from a Java program. In such a case (NO in step S0502), the processing proceeds to step S0505. In step S0505, the Java VM window structure management unit 102 passes the ID of BASEWindow stored therein to the Java VM window generation unit 101. In step S0506, the Java VM window generation unit 101 transmits a command to generate the window of Frame to the X Window generation unit 201, with the ID of BASEWindow specified as that of the parent window. In this way, the Frame is generated as a child window of BASEWindow as illustrated in FIG. 4B.

Information about the window generated by the X Window generation unit 201 is transmitted to the X Window structure management unit 202. The X Window structure management unit 202 manages a plurality of X Windows, which includes not only the X Windows generated by the Java VM window generation unit 101 but also the X Windows generated by the native window generation unit 302.

The X Window structure management unit 202 gives a command to the X Window drawing unit 203 about which windows to overlay and display in what manner. Then, the X Window drawing unit 203 generates graphic data according to the command and transmits the graphic data to the screen drawing unit 401. The screen drawing unit 401 displays the windows on the screen. According to such a method, the parent window of Frame is generated as not XRootWindow but BASEWindow. As a result, the native window manager 300 can transmit events to the Frame and to the Label and Button located under the Frame. The Frame has conventionally been generated with XRootWindow as its parent window, in which case the native window manager 300 may not be able to detect the Frame or transmit an event thereto. The reason is that the notification destination of event transmission is only the child windows of BASEWindow. As described above, according to the present exemplary embodiment, events can be transmitted.

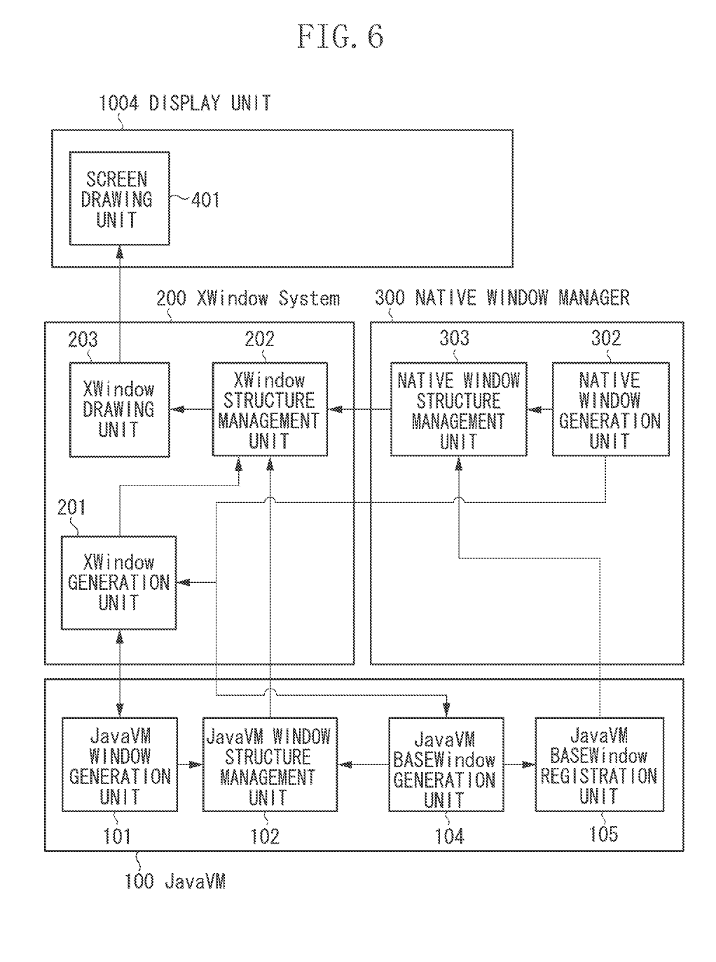

In a second exemplary embodiment, unlike the first exemplary embodiment, BASEWindow is generated not by the native window manager 300 but by the Java VM 100. FIG. 6 is a block diagram of the present exemplary embodiment. FIG. 6 differs from FIG. 3 in that there are a Java VM BASEWindow generation unit 104 and a Java VM BASEWindow registration unit 105 and there is neither the Java VM BASEWindow acquisition unit 103 nor the BASEWindow generation unit 301. In other respects, FIG. 6 is similar to FIG. 3. The following description deals only with differences. The Java VM BASEWindow generation unit 104 has a function of commanding the X Window generation unit 201 to reserve an ID for identifying a window and reserve a memory area.

The Java VM BASEWindow registration unit 105 has a function of receiving information about BASEWindow from the Java VM BASEWindow generation unit 104 and registering the information in the native window structure management unit 303.

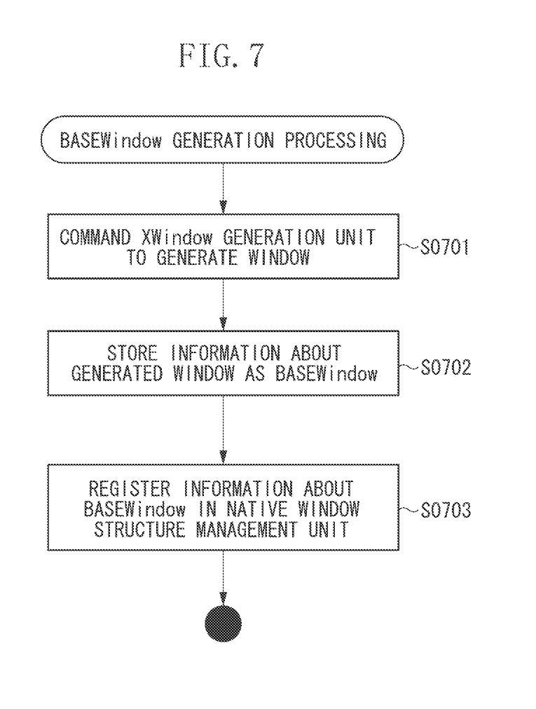

Next, BASEWindow generation processing will be described with reference to FIG. 7. In step S0701, the Java VM BASEWindow generation unit 104 initially commands the X Window generation unit 201 to generate a window. At that time, the Java VM BASEWindow generation unit 104 specifies the ID of XRootWindow as that of the parent window. In step S0702, the Java VM BASEWindow generation unit 104 stores information about the generated window, and notifies the Java VM window structure management unit 102 of the ID of the generated window. In step S0703, the Java VM BASEWindow registration unit 105 registers the information about BASEWindow in the native window structure management unit 303. In this way, BASEWindow is not generated when the Java VM 100 does not need BASEWindow, like when no Java application is activated. This provides a benefit in resource saving, compared to the first exemplary embodiment in which the native window manager 300 generates a BASEWindow intended for the Java VM 100 even if the Java VM 100 needs no BASEWindow.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-109336, filed May 31, 2016, which is hereby incorporated by reference herein in its entirety.

What is claimed is:

1. An apparatus for running an application on a virtual machine, the apparatus comprising:
a management unit configured to manage a window of an application different from the application run on the virtual machine on a window management system;
a first generation unit configured to generate a base window capable of event notification from the window management system on the window management system; and
a second generation unit configured to generate a window included in display of the application run on the virtual machine in a hierarchical structure with the base window as a top level.

2. The apparatus according to claim 1, further comprising a notification unit configured to notify the window included in the display of the application to run on the virtual machine of an event by using the base window.

3. The apparatus according to claim 2, wherein the notification unit is configured to notify the window included in the display of the application to run on the virtual machine of the event through the hierarchical structure.

4. The apparatus according to claim 1, wherein the base window is generated for each application to run on the virtual machine.

5. The apparatus according to claim 1, wherein the first generation unit is configured to determine whether the application to run on the virtual machine is activated, and if the application is activated, generate the base window.

6. The apparatus according to claim 1, further comprising a registration unit configured to register the base window as a notification destination of the event notification.

7. The apparatus according to claim 6, wherein the registration unit is configured to use an ID for registration.

8. A method of an apparatus for running an application on a virtual machine, the method comprising:
managing a window of an application different from the application to run on the virtual machine on a window management system;
generating a base window capable of event notification from the window management system on the window management system; and
generating a window included in display of the application run on the virtual machine in a hierarchical structure with the base window as a top level.

9. The method according to claim 8, further comprising notifying the window included in the display of the application to run on the virtual machine of an event by using the base window.

10. The method according to claim 9, further comprising notifying the window included in the display of the application to run on the virtual machine of the event through the hierarchical structure.

11. The method according to claim 8, wherein the base window is generated for each application to run on the virtual machine.

12. The method according to claim 8, further comprising determining whether the application to run on the virtual machine is activated, and if the application is activated, generating the base window.

13. The method according to claim 8, further comprising registering the base window as a notification destination of the event notification.

14. The method according to claim 13, wherein the registering uses an ID for registration.

15. A non-transitory storage medium storing a program causing a computer to perform a method for running an application on a virtual machine, the method comprising:
managing a window of an application different from the application to run on the virtual machine on a window management system;
generating a base window capable of event notification from the window management system on the window management system; and
generating a window included in display of the application run on the virtual machine in a hierarchical structure with the base window as a top level.

16. The non-transitory storage medium according to claim 15, further comprising notifying the window included in the display of the application to run on the virtual machine of an event by using the base window.

17. The non-transitory storage medium according to claim 16, further comprising notifying the window included in the display of the application to run on the virtual machine of the event through the hierarchical structure.

18. The non-transitory storage medium according to claim 15, wherein the base window is generated for each application to run on the virtual machine.

19. The non-transitory storage medium according to claim 15, further comprising determining whether the application to run on the virtual machine is activated, and if the application is activated, generating the base window.

20. The non-transitory storage medium according to claim 15, further comprising registering the base window as a notification destination of the event notification.
